(19) United States
(12) Patent Application Publication
(10) Pub. No.: US 2026/0311087 A1
(43) Pub. Date: Oct. 8, 2026

(54) DISCOVERY OF DEPLOYED APPLICATIONS

(71) Applicant: Palo Alto Networks, Inc., Santa Clara, CA (US)

(72) Inventors: Praveen Kumar Sinha, San Jose, CA (US); Srikumar Narayan Chari, Cupertino, CA (US); Hariprasanna Srinivasan, San Jose, CA (US)

(21) Appl. No.: 19/173,663

(22) Filed: Apr. 8, 2025

(51) Int. Cl. G06Q 10/0631; G06Q 10/0875

(52) U.S. Cl. CPC G06Q 10/06315; G06Q 10/0875

(57) ABSTRACT

A system has been created that can discover the underlying cloud computing assets of cloud-native applications or discover the cloud computing assets underlying a business function. The system accesses an inventory of cloud-computing assets of an organization to retrieve information about the cloud-computing assets and group the cloud-computing assets by similarity of selected asset attributes. The system then builds a graph(s) of the cloud-computing assets and relationships among the cloud-computing assets. Initially, the cloud-computing assets are related based on the grouping. The system expands upon the relationships among cloud-computing assets revealed by the grouping to relate to cloud-computing assets external to the groups, between groups, and with pseudo-assets (e.g., roles). This expansion can relate cloud-computing assets that were previously unrelated and/or add additional relationships between cloud-computing assets. The system processes the graph to extract one or more strongly connected components that satisfy a minimum relationship strength threshold.

### BACKGROUND

The disclosure generally relates to discovering cloud computing assets that implement an application or business function (e.g., CPC subclass G06F 17/00).

Cloud service providers (CSPs) offer cloud computing resources as services to customers of the CSP according to a cloud computing model, such as Infrastructure-as-a-Service (IaaS) or Platform-as-a-Service (PaaS). IaaS provides resources including compute, storage, networking, and virtualization resources. PaaS provides, in addition to IaaS resources, resources for building, deploying, and managing applications, such as databases and development tools. A PaaS offering can include a continuous integration/continuous delivery (CI/CD) pipeline. For a web application, a CI/CD pipeline can include a repository, a version control system, a build automation tool, an image registry, and tools for automatic production environment provisioning and deployment. Data describing such resources can be accessed via an application programing interface(s) (APIs) provided by the CSP.

### BRIEF DESCRIPTION OF THE DRAWINGS

Embodiments of the disclosure may be better understood by referencing the accompanying drawings.

FIG. 1 is a diagram of a system for discovering the cloud-computing assets which implement functions of applications deployed for an organization.

FIG. 2 is a diagram of an example GUI of a dashboard depicting an application definition.

FIG. 3 is a diagram of an example graphical user interface (GUI) of a dashboard depicting an application graph.

FIG. 4 is a flowchart of example operations for discovering cloud-computing assets implementing cloud-native application(s).

FIG. 5 is a flowchart of example operations for building application graph(s).

FIG. 6 depicts an example computer system with an application discovery system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The description uses the term “cloud computing asset” to refer to a cloud computing resource provisioned, purchased, or leased by an organization.

Generally, a “business function” refers to a collection of tasks or processes that operate in a sequence to produce a service or product of a business. This description uses the term “business function” in the context of cloud computing to describe a collection of cloud computing assets used together to implement a service (or microservice) that produces an output for a cloud-native application. A cloud-native application is not a traditional, monolithic application, but is an application built and deployed according to a cloud-native architecture. Cloud computing resources of a cloud-native architecture include microservices, a service mesh, containers, orchestration, APIs, and DevOps (Development and Operations) tools. A cloud-native application can provide or use one or more business functions. Thus, a cloud-native application can be logically modularized into multiple business functions, such as a first business function corresponding to a first collection of cloud-computing assets and a second business function corresponding to a second collection of cloud-computing assets. And it is possible that the first and second collections overlap.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Introduction

Knowledge about business functions of an organization assists administrators of the organization with security posture management (SPM). Many organizations rely on tagging cloud-computing resources to identify a collection of resources which implement an application. Tagging, however, requires diligence and is prone to human error. The errors and/or incompleteness of tagging and reliance on tagging for SPM can lead to less than effective security and security gaps that can be exploited.

### Overview

A system has been created that can discover the underlying cloud computing assets of cloud-native applications or discover the cloud computing assets underlying a business function. The system accesses an inventory of cloud-computing assets of an organization to retrieve information about the cloud-computing assets and group the cloud-computing assets by similarity of selected asset attributes. The system then builds a graph(s) of the cloud-computing assets and relationships among the cloud-computing assets. Initially, the cloud-computing assets are related based on the grouping. The system expands upon the relationships among cloud-computing assets revealed by the grouping to relate to cloud-computing assets external to the groups, between groups, and with pseudo-assets (e.g., roles). This expansion can relate cloud-computing assets that were previously unrelated and/or add additional relationships between cloud-computing assets. The system processes the graph to extract one or more strongly connected components that satisfy a minimum relationship strength threshold. For an identified strongly connected component that satisfies the threshold, the system determines distinct values of attributes of the cloud-computing assets in the strongly connected component and generates a description for a business function or application implemented with the collection of cloud-computing assets in the strongly connected component. The definitions, along with the business function or application graph data, can be provided for various downstream consumption. For instance, an administrator can use the definition to inform security policy authoring and other aspects of SPM. As another example, root cause analysis of an issue can leverage a definition of an application or business function and the graph data.

### Example Illustrations

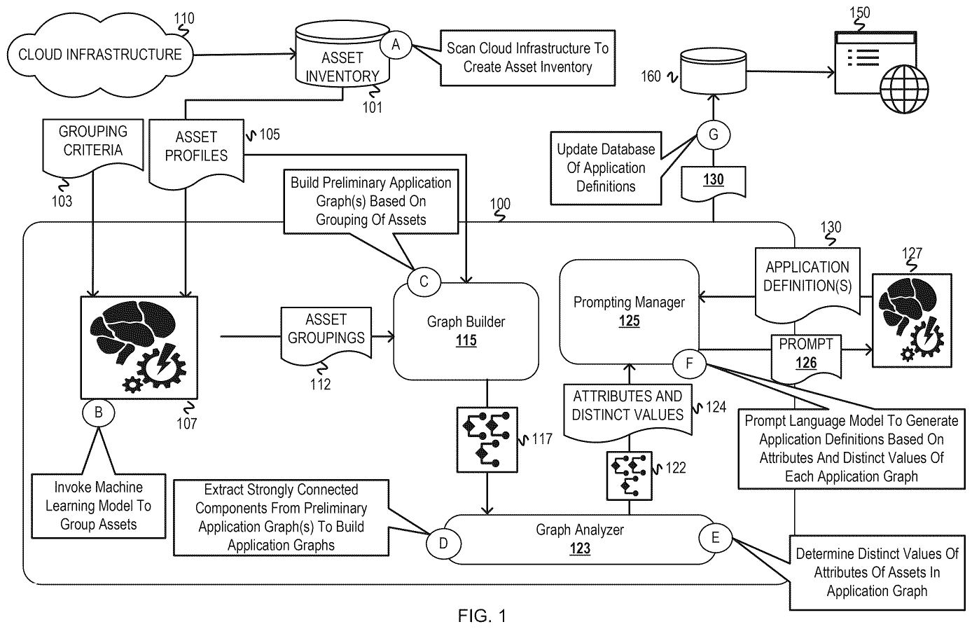

FIG. 1 is a diagram of a system for discovering the cloud-computing assets which implement functions of applications deployed for an organization. FIG. 1 depicts an application discovery system 100 that discovers applications and their corresponding assets. Application discovery can also encompass the discovering of business functions of an application based on the use-case of the application discovery system 100. The application discovery system 100 includes a machine learning model 107, a graph builder 115, a graph analyzer 123, and a prompting manager 125.

FIG. 1 is annotated with a series of letters A-G representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the application discovery system 100 scans cloud infrastructure 110 to create an asset inventory 101. The application discovery system 100 identifies cloud-computing resources hosted on the cloud infrastructure 110 which were provisioned for applications of an organization. To create the asset inventory 101, the application discovery system 100 extracts metadata for each identified asset and formats the metadata for each asset into a format, such as JavaScript® Object Notation (JSON). The application discovery system 100 stores the formatted asset metadata (“asset profiles”) as entries in the asset inventory 101.

At stage B, the application discovery system 100 invokes the machine learning model 107 to group assets based on grouping criteria 103. The application discovery system 100 retrieves asset profiles 105 for assets in the asset inventory 101. The application discovery system 100 obtains the grouping criteria 103 from a user interface or configuration data. The grouping criteria 103 correspond to different asset attributes. Examples of asset attributes include application programming interface (API) names, logical groupings (e.g., associated account, namespace, repository usage), Uniform Resource Locator (URL) components of a domain name, and tags. The application discovery system 100 invokes the machine learning model 107 to group the assets corresponding to the asset profiles 105 based on the values of the attribute(s) indicated by the grouping criteria 103. FIG. 1 presumes the grouping yields multiple groups and depicts asset groupings 112 determined by the machine learning model 107. The asset groupings 112 can include assets that do not have group membership (e.g., outliers).

At stage C, the graph builder 115 receives the asset groupings 112 from the machine learning model 107 and builds a preliminary application graph(s) 117 that indicates assets and asset relationships. The graph builder 115 analyzes the asset profiles 105 retrieved from the asset inventory 101 to identify one or more relationships between assets of the asset groupings 112. Based on the identified relationships, the graph builder 115 generates a graph for each asset grouping 112. For each generated graph, the graph builder 115 expands the graph by identifying pseudo-assets (e.g., roles, security groups, subnets) which are indicated by the asset profiles corresponding to the assets in each graph. For example, a serverless function's asset profile can indicate a role. That role is added to the corresponding graph as a node along with the corresponding edge representing the relationship between the role and the serverless function. The graph builder 115 then identifies additional relationships between assets in the generated graphs and asset groupings with ungrouped assets. The building process can connect two or more graphs directly or indirectly via an ungrouped asset or pseudo-asset. The graph builder 115 generates edges relating nodes representing assets/pseudo-assets and assigns weights to edges based on the corresponding relationship type and/or other weighting factors, such as related nodes. These relationship weights are configurable based on domain knowledge and/or weight biasing preferences.

At stage D, the graph analyzer 123 receives the preliminary application graph(s) 117 and extracts strongly connected components from each graph to build application graph(s) 122. The graph analyzer 123 traverses the preliminary application graph(s) 117 to extract strongly connected components that satisfy a relationship strength criterion based on the edge weights. The graph analyzer 123 can invoke a graph walking algorithm (e.g., Pregel walk algorithm) parameterized according to the relationship strength criterion and traverse the preliminary application graph(s) 117 and identify the strongly connected components with links that satisfy the relationship strength criterion. The system infers that each strongly connected component 122 that satisfies the relationship strength criterion corresponds to an application or business function (“application graph”).

At stage E, the graph analyzer 123 determines distinct values of attributes of assets in each application graph 122. These distinct values for attributes are collected as context for a language model to generate a definition for the business function or application implemented by the discovered assets. The distinct values can also be used to further refine and/or separate assets. While a graph of assets can be inferred as a collection of assets that implement a business function or application, the collection may be further logically separated by an attribute for a business reason. For instance, an owner attribute can be used to separate a collection of assets into collections by security or information technology (IT) owner assuming delineation by owner corresponds to a business reason.

At stage F, the prompting manager 125 prompts a language model 127 to generate an application definition(s) 130 based on the attributes and distinct values of assets in the application graph(s) 122. The prompting manager 125 submits a prompt 126 to the language model 127 with instructions to generate an application definition for an application corresponding to the application graphs 122. The prompt 126 includes the attribute profiles for each asset in the application graphs and the distinct attribute values determined for each application. The prompt 126 also includes task instructions to determine the following information for an application definition: an application name, a summary/description of the application, an application's owner, a testing/production environment of the application, and an application's business critical assets. If there are multiple applications graphs 122, then the prompting manager 125 may separately prompt the language model 127 for each discovered application.

At stage G, the application discovery system 100 updates a database 160 of application definitions with the application definition(s) 130 generated by the language model 127. The application discovery system 100 also stores the corresponding application graph(s) 122. The application graph data and corresponding definitions in the database 160 can then be retrieved to update a view 150 (e.g., a dashboard within a user interface) to display the different applications discovered for an organization.

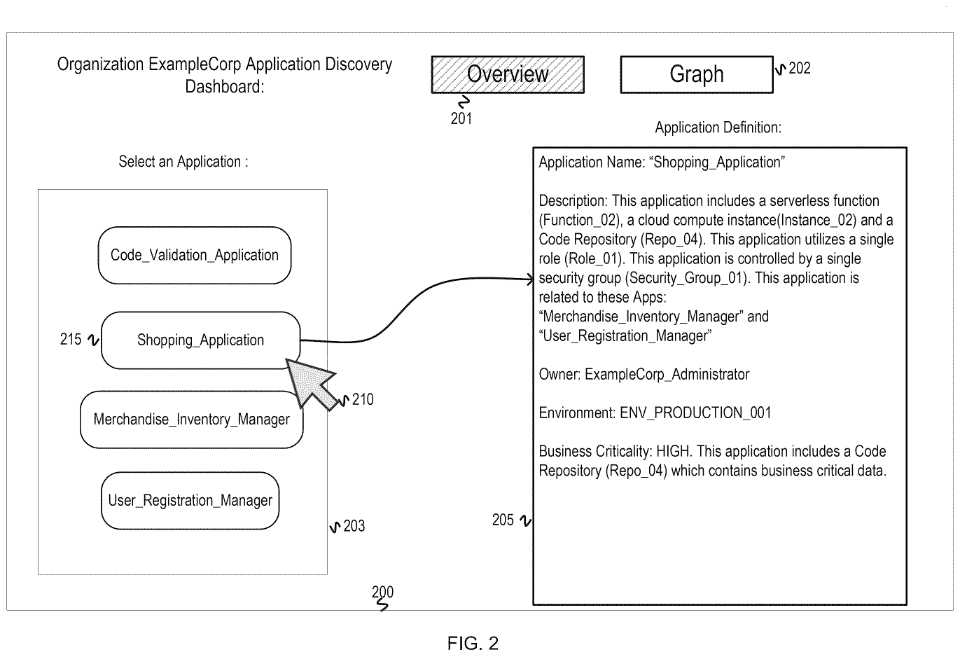

FIG. 2 is a diagram of an example GUI of a dashboard depicting an application definition. FIG. 2 depicts a dashboard 200 belonging to an organization with the identifier “ExampleCorp”. At the top of the dashboard 200, FIG. 2 depicts two buttons 201 and 202 labeled “Overview” and “Graph” respectively. The “Overview” button 201 is depicted with crosshatching to indicate selection to cause the dashboard 200 to show an overview of the currently selected application 215. On the left side of the dashboard, FIG. 2 depicts a list of discovered applications 203 which belong to ExampleCorp. FIG. 2 depicts a cursor 210 over the currently selected application 215 labeled “Shopping_Application” to illustrate that a user has selected the application 215 in the dashboard 200. On the right side of the dashboard 200, FIG. 2 presents an application definition 205 for the application 215. The application definition 205 includes a name, a description of the application, the application's owner, the environment corresponding to the application, and the application's business criticality. The application definition 205 depicted in FIG. 2 reads:
Application Name: “Shopping_Application”
Description: This application includes a serverless function (Function_02), a cloud compute instance(Instance_02) and a Code Repository (Repo_04). This application utilizes a single role (Role_01). This application is controlled by a single security group (Security_Group_01). This application is related to these Apps:
“Merchandice_Inventory_Manager” and
“User_Registration_Manager”
Owner: ExampleCorp_Administrator
Environment: ENV_PRODUCTION_001
Business Criticality: HIGH. This application includes a Code Repository (Repo_04) which contains business critical data.

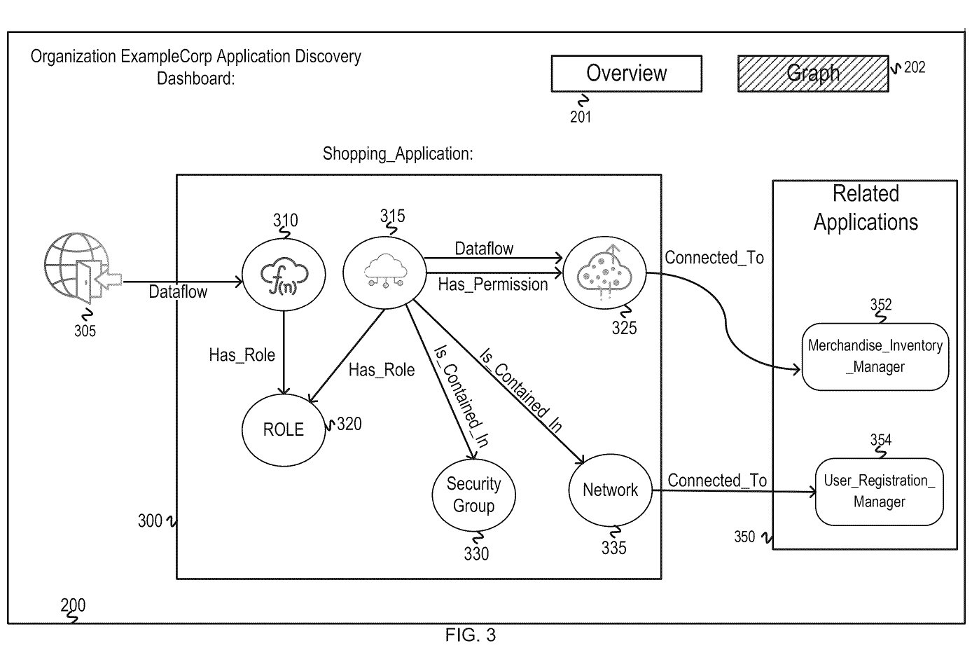

The application 215 depicted in FIG. 3 has a business criticality rating of “High” because the application includes a code repository asset which contains business critical data. The application definition 205 also specifies the corresponding application's environment as: “ENV_PRODUCTION_001”. This indicates the application corresponds to a production environment. While an environment is generally a production environment or a test environment, an organization can be more specific about the environment. For example, an organization can specify development, integration, or stage as the environment.

FIG. 3 is a diagram of an example graphical user interface (GUI) of a dashboard depicting an application graph. FIG. 3 depicts the same dashboard 200 as depicted in FIG. 2, but in this example the “Graph” button 202 has crosshatching to indicate its selection to cause the dashboard 200 to show an application graph 300 for the application selected in FIG. 2. The application graph 300 includes the assets which were identified in the description portion of the application definition depicted in reference to FIG. 2. The application graph 300 includes the following assets: a serverless function 310, a cloud computing instance 315, and a code repository 325. The application graph 300 also includes the following pseudo-assets: a Role 320, a Security Group 330, and a Network pseudo-asset 335. FIG. 3 also depicts edges of the application graph which are labeled based on the relationship(s) between the assets. For example, the cloud compute instance 315 has both a “Dataflow” and a “Has_Permission” relationship with the code repository 325. The dashboard 200 additionally depicts an API gateway 305 which maps API requests to a serverless function 310, which is represented by the relationship “Dataflow.” Although the gateway 305 is not part of the application graph 300, it is depicted by the dashboard 200 to provide additional context to the application.

FIG. 3 also depicts a section of the dashboard 350 which depicts two related applications which are related to the shopping application. The first related application 352 is labeled “Merchandise_Inventory_Manager” and shares a connection with the code repository 325. The second related application 354 is labeled “User_Registration_Manager” and shares a connection with the network pseudo-asset 335. Similar to the API gateway 305, these related applications are not part of the application graph 300 but are depicted on the dashboard 200 to provide additional context to the shopping application.

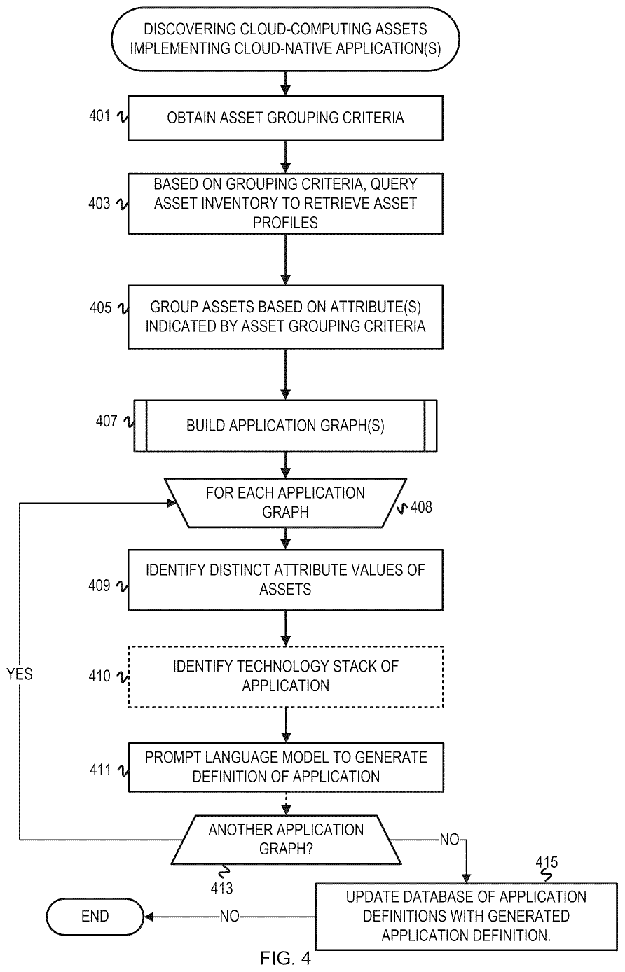

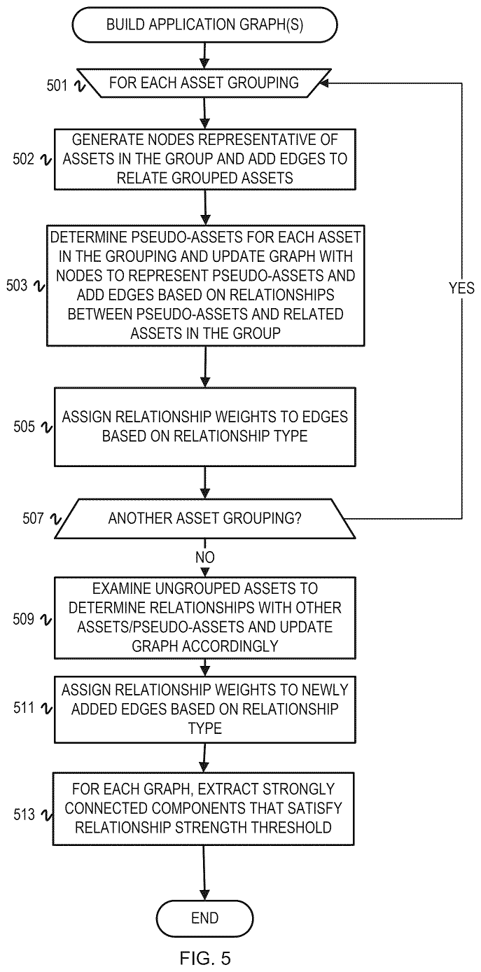

FIGS. 4 and 5 are example flowcharts for discovering cloud-computing assets implementing cloud-native application(s). The example operations are described with reference to an application discovery system for consistency with the FIGS. 1-3 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. FIGS. 4 and 5 describe a case in which the system discovers assets implementing an application.

FIG. 4 is a flowchart of example operations for discovering cloud-computing assets implementing a cloud-native application(s). The descriptions for these example operations refers to “cloud-computing assets” as “assets” for brevity. The operations of FIG. 4 presume an asset inventory of asset profiles has already been created.

At block 401, the application discovery system obtains asset grouping criteria. An asset grouping criteria can be a manual or automatic selection of one or more of attributes, which can be application programming interface (API) identifier, account, namespace, domain name, and tag attributes. The application discovery system can obtain the grouping criteria from a user interface or configuration data. An application owner can specify, through the user interface, a set of asset attributes to use when grouping assets based on their knowledge of the application or business function. Asset grouping criteria obtained from configuration data includes a set of asset attributes which can be used to determine asset groupings. The set of asset attributes can be determined based on user-provided feedback and analysis of asset coverage determined through experimentation with different sets of asset attributes.

At block 403, the application discovery system, based on the asset grouping criteria, queries an asset inventory to retrieve asset profiles. Based on the asset attributes indicated by the grouping criteria, the application discovery system retrieves asset profiles with metadata corresponding to the indicated attributes. To illustrate, the asset attributes that have been selected for the grouping criteria are API endpoint, account, and tags that include the string “app.” Accordingly, the application discovery system would retrieve asset profiles with fields or keys corresponding to API endpoint, account, and tags that includes the specified string.

At block 405, the application discovery system groups assets based on the obtained asset grouping criteria and retrieved asset profiles. The asset attributes selected for the grouping criteria influence the grouping. For instance, the grouping operations can prioritize the grouping according to the ordering of asset attributes. This ordering can be statically defined based on heuristics or configurable to account for customer knowledge or familiarity with the assets or preferences. Grouping assets can be performed with different techniques that involve machine learning and/or natural language processing. For example, asset grouping can be done with a clustering algorithm (e.g., Hierarchical Density-Based Spatial Clustering of Applications with Noise (HDBSCAN or k-means clustering), term frequency analysis, and/or term frequency-inverse document frequency (TF-IDF) analysis. Embodiments can use multiple grouping techniques or a single grouping technique. Selection of the grouping technique may depend on the grouping criteria.

As an example, term frequency can be selected as a grouping technique if the tags attribute has been selected as a grouping criterion along with the logical grouping attribute account. The system determines distinct or unique tags that occur across assets and calculates term frequency for each tag. The system then filters out tags by cardinality. For example, the system filters out tags with a cardinality outside a specified range of deviation from the median cardinality. The margin of deviation is defined based on a determination of the bounds for low and high cardinality. The system ranks the remaining tags by term frequency and selects the tags with the top N cardinality. The system then groups tags by tag similarity with each of the selected tags. Similarity can be based on semantic similarity determined with embeddings and/or fuzzy matching. Tags determined as similar can be coalesced into a single representative tag value. For instance, tag values “Application,” “app,” “appID,” and “project” can be coalesced into the representative tag value “Application.” The system then successively groups by the precedence of the grouping criterion. The system first groups assets by account-resources of a same account are grouped together. Within each account group, the system groups assets by similarity of values of the top N tags, possibly as represented by a representative tag values determined from coalescing. Embodiments can further organize the asset groupings so that constituent assets have unique combinations of values for the top N tags with respect to the other members of a group. Based on the groups yielded from the grouping, the system infers that each grouping of assets implements an application or business function.

As an example of using k-means clustering for grouping, the system preprocesses the values of each of the grouping criteria attributes. For each asset, the system converts values of categorical attributes into numerical indexes (e.g., using StringIndexer) and then uses one-hot encoding on the indexes. For tags, the system preprocesses the tag values to identify the distinct tag values and creates a bitmap index that represents the different tag values and sets the bitmap index for each asset. For each asset, the system forms a feature vector and then the system trains the k-means clustering model with the feature vectors. The resulting clusters can be named based on tags of cluster members. For example, tag frequency can be calculated within each cluster and the most frequent tag used to name the cluster.

Grouping can also use TF-IDF or hierarchical clustering instead of k-means clustering or in addition to k-means clustering. If multiple grouping techniques are used, the results are evaluated and a “best” grouping is selected according to evaluation criteria based on coverage (e.g., percentage of total assets within a group) and efficacy. For instance, efficacy can be evaluated with manual testing and validation of randomly selected samples (“dipstick evaluation”). At block 407, the application discovery system builds application graph(s) based on the asset groupings. The system builds the graph to expand from the groupings coverage of assets that may implement a same application or business function. FIG. 5 provides example operations that elaborate on the graph building.

At block 408, the application discovery system begins iterating through each application graph generated by the application discovery system. In some cases, the grouping will yield n groups and relating of assets in the graph building will yield m graphs, where m<=n. Operational flow continues at block 409.

At block 409, the application discovery system identifies distinct attribute values of assets. The application discovery can be configured to examine specific attributes which can be used as context for generating an application definition. The application discovery system parses the asset profiles to identify metadata corresponding to the attributes specified by the configuration. Some distinct values can be used to refine and/or separate assets. A graph of assets can be separated into collections of asset nodes and edges based on distinct attribute values. For example, for a business reason, the application discovery system may divide an application graph into multiple sub-graphs based on ownership indicated by the assets. In some implementations, certain distinct attribute values (e.g., ownership, role) can be used to filter out asset nodes with distinct values that are largely different from the majority of assets in the application graph. Using ownership as an example again, if 90% of assets nodes belong to entity A and 10% belong to entity B, then the system can remove the asset nodes that belong to entity B instead of separating the graph into two sub-graphs.

At block 410, the application discovery system identifies a technology stack for the application. The technology stack can be information that provides more context for definition generation. If available, the results of Software Composition Analysis (SCA) and/or a Software Bill of Materials can be analyzed to identify an entry points or primary processes of a software package and then determine technology stack information. The system can identify a main executable based on naming conventions. The system can analyze dependencies to identify the components with the most dependencies as these components will likely be a framework or core library. A primary process may be identified based on metadata that indicates “server”, “service”, or “daemon.” Metadata of the identified components can be extracted as technology stack information. Block 410 is dashed to illustrate it is an optional operation since SCA results or a SBOM may not be available.

At block 411, the application discovery system generates an application definition. The application discovery system prompts a generative AI model (e.g., a large language model (LLM)) to generate the application definition based on the attributes used in grouping and determined distinct attribute values of the application. The prompt includes the attribute values for each asset in the application graph and the distinct attribute values determined for each application. The prompt includes task instructions to generate a name for the application, generate a summary/description of the application, determine the application's owner (or a contact within the organization who maintains the application's assets), determine the environment of the application, and determine the application's business criticality and business critical assets. In cases where a technology stack has been determined, the technology stack and additional analysis determined by the SCA tool is included in the prompt to enhance the application definition. Implementations can include additional information from the asset profiles to provide additional context. The dashed block between block 411 and block 413 indicates the application discovery system obtains the application definition before operational flow proceeds to block 413.

At block 413, the application discovery system determines if there is another application graph to process. If there is another application graph, then operational flow returns to block 408. Otherwise, operational flow continues at block 415.

At block 415, the application discovery system updates a database of application definitions with the generated application definition(s). The applications in the database can be indexed using an identifier such as a unique identifier (UID) generated by the application discovery system for the application. The application discovery system also stores the application graph corresponding to each discovered application in association with the application definitions. In some implementations, the application discovery system may additionally use the application definitions and corresponding graph data to update a user interface (e.g., a dashboard) such that an administrator can browse and view the discovered applications for their organization.

FIG. 5 is a flowchart of example operations for building an application graph(s). The example operations of FIG. 5 presume asset grouping have been determined and conveyed for graph building.

At block 501, the application discovery system begins iterating through each asset grouping. The asset groupings may be indexed by cluster label or tag derived names. The graph building begins with the asset groupings since the groupings are an initial basis for relating the constituent assets.

At block 502, the application discovery system generates nodes representative of assets in the group and adds edges to relate the nodes of the grouped assets. The application discovery system analyzes the asset profiles of each asset for indications of relationships with other assets in grouping. These relationships can be configuration based and/or dataflow based. For example, a serverless function asset's profile can indicate an API gateway asset which maps function calls to the serverless function. This is an example of a dataflow relationship between the two assets. The application discovery system can be configured to evaluate specific fields of metadata in the asset profiles which are likely to indicate relationships. Different types of assets can indicate different types of relationships. The application discovery system can be configured to evaluate each asset's metadata based on the asset's type. In some implementations, the application discovery system can identify relationships based on retrieving additional documentation which indicates asset relationships. Example documentation includes Infrastructure-as-Code files and domain name system (DNS) logs. For each identified relationship, the application discovery system adds an edge between the corresponding asset nodes representing the relationship. As depicted in FIG. 3, assets can have multiple relationships with the other assets. The cloud compute instance depicted in FIG. 3 has both a “Dataflow” and a “Has_Permission” relationship with the repository. The application discovery system may label the edges of the graph based on their relationship type (e.g. “Contained_In” or “Dataflow”).

At block 503, the application discovery system determines pseudo-assets for each asset in the grouping and updates the graph with nodes representing the pseudo-assets. The application discovery system adds edges based on the relationships between the pseudo-assets and assets in the group. The application discovery system parses asset profiles for each asset node in the graph to identify pseudo-assets (e.g., roles, subnets, security groups, etc.). Based on detecting a pseudo-asset indicated in an asset profile, the application discovery system generates an asset node representing the pseudo-asset and adds an edge between the pseudo-asset and the corresponding asset node. Pseudo-assets can indicate different types of relationships than those between assets (e.g. “has_role”).

At block 505, the application discovery system assigns relationship weights to edges based on the edge's indicated relationship type. The weights quantify strength of a relationship between nodes. The application discovery system can be configured with a mapping of relationship types and weights. Based on the relationship type of each edge, the application discovery system references the mapping of relationship types and assigns the corresponding weight to the edge. The weights can be normalized values (e.g., 0-1). Other factors can influence weighting. Weights can be assigned to an edge based on the types of nodes connected by the edge. Weights can be assigned to the nodes and included in computing the strength of a path.

At block 507, the application discovery system determines if there is another asset grouping to process. If there is another asset grouping, the operational flow returns to block 501. Otherwise, operational flow continues at block 509.

At block 509, the application discovery system examines ungrouped assets to determine relationships with other assets/pseudo-assets and updates the graph accordingly. The application discovery system parses the asset profiles of ungrouped assets to identify indications of relationships with assets in any of the asset groupings. For each identified relationship, the application discovery system updates the graph by adding an edge between the ungrouped asset and corresponding asset/pseudo-asset representing the relationship. The graph building can result in two or more graphs being directly or indirectly connected via an ungrouped asset or pseudo-asset.

The edges generated in blocks 502, 503, and 509 are directed edges. The direction of the edges in this case is based on the type of the relationship and the types of the corresponding assets/pseudo-assets. For example, an API gateway can have a dataflow relationship with a serverless function, where the edge is directed from the API gateway to the serverless function. Some relationships (e.g., two-way dataflow relationships) are represented as bi-directional edges or edges in each direction depending upon implementation.

At block 511, the application discovery system assigns weights to the newly added edges based on relationship type. The application discovery system references the mapping of relationship types to weights to determine the assigned weight for each relationship represented by the newly added edges.

At block 513, the application discovery system, for each graph, extracts strongly connected components that satisfy a relationship strength threshold. The application discovery system can call a library function or make an API call to crawl each graph and extract the strongly connected components. The application discovery system can include a parameter to the function which specifies a configured relationship strength threshold value that aggregated edge weights must satisfy to be included in the output graph. When traversing the graph, the application discovery system aggregates the weights of all edges in the direction of traversal. The strength threshold can be a configurable value to bias towards coverage or accuracy.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 409 and 410 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

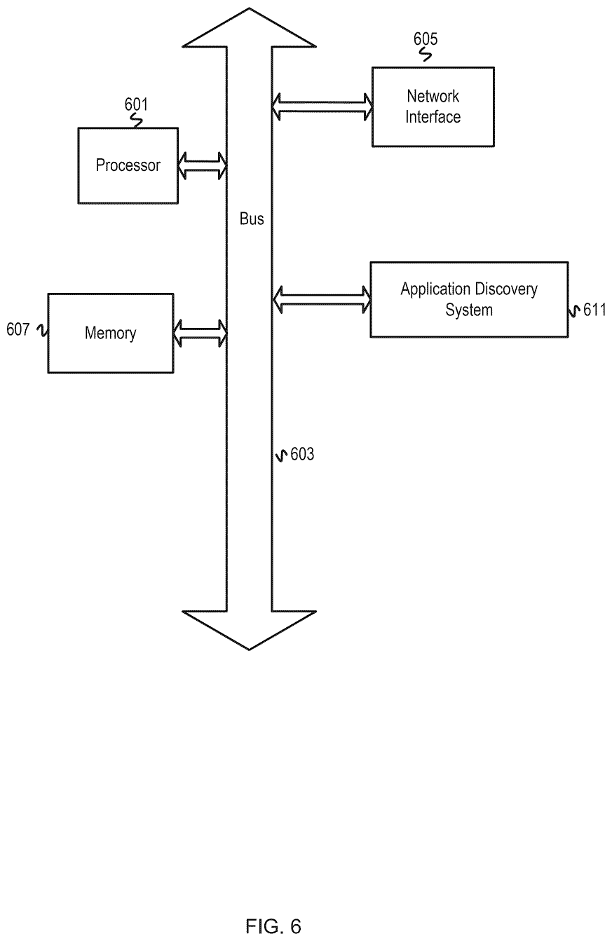

FIG. 6 depicts an example computer system with an application discovery system. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes an application discovery system 611. The application discovery system 611 discovers collections of cloud-computing assets that implement a business function or application according to a business perspective represented by grouping criteria. The grouping criteria are specified by user interface, configuration, or analysis of the assets. The application discovery system 611 groups assets by the grouping criteria as an initial inference of collections that implement an application or business function. The application discovery system 611 uses the groupings as an initial basis for graph building and discovers more relationships by updating the graph based on further examination of asset attributes. The application discovery system 611 traverses the graph to extract strongly connected components that satisfy a relationship strength threshold as a collection of assets that likely implement a business function or application. The application discovery system 611 can use generative AI to generate a definition for the inferred application or business function. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
discovering that a first collection of cloud computing resources of an organization corresponds to a business function, wherein discovering that the first collection corresponds to a business function comprises,
grouping a plurality of cloud computing resources by similarity based, at least in part, on a set of one or more attributes of the plurality of cloud computing resources;
generating a set of one or more graphs of the plurality of cloud computing resources based, at least in part, on the grouping and pre-defined resource relationships;
extracting one or more strongly connected components from each graph based on weights assigned to relationships in the graph and a defined threshold of relationship strength; and
for a first strongly connected component, identifying distinct values of at least a first attribute of the cloud computing resources indicated in the first strongly connected component, wherein the first attribute corresponds to the business function and the first strongly connected component indicates the first collection of cloud computing resources; and
prompting an artificial intelligence (AI) model to generate a definition for the first collection of cloud computing resources based, at least in part, on values of attributes of the first collection of cloud computing resources.

2. The method of claim 1 further comprising creating an inventory of resources of an organization, wherein the inventory comprises the plurality of cloud computing resources.

3. The method of claim 1, wherein grouping the plurality of cloud computing resources by similarity comprises at least one of invoking a clustering algorithm on the plurality of cloud computing resources with each cloud computing resource represented by an embedding of values of the one or more attributes, invoking a clustering algorithm on the plurality of cloud computing resources based on term frequency-inverse document frequency (TF-IDF) scores for the plurality of cloud computing resources based on attribute values, and grouping the plurality of cloud computing resources by frequency distribution of values of the one or more attributes.

4. The method of claim 1, wherein identifying distinct values of at least the first attribute of the cloud computing resources indicated in the first strongly connected component comprises obtaining statistical measurements of terms in values of the one or more attributes of the first collection of cloud computing resources according to term frequency-inverse document frequency (TF-IDF) and selecting as the distinct values those values with a TF-IDF score that satisfies a defined threshold.

5. The method of claim 1, further comprising traversing each graph according to a random walking algorithm, wherein extracting the one or more strongly connected components is based, at least in part, on the traversing.

6. The method of claim 1, wherein the one or more attributes corresponds to at least one of domain, logical group, tag, and application programming interface.

7. The method of claim 1 further comprising:
determining whether one of the first collection of cloud computing resources corresponds to a software bill of materials (SBOM) or results of a software composition analysis (SCA); and
determining a technology stack for the first collection of cloud computing resources based on the SBOM or the SCA results,
wherein prompting the AI model to generate the definition comprises prompting the AI model to generate an application or business function name based, at least in part, on the technology stack.

8. The method of claim 1, wherein prompting the AI model to generate the definition comprises prompting the AI model to:
generate a name for the first collection based on at least one of tags of the first collection and an application programming interface endpoint indicated in the first collection; and
generate as a description a summary of the set of attributes for the grouping, values of the set of attributes of the first collection of cloud computing resources, and the distinct values.

9. The method of claim 8, wherein prompting the AI model to generate the definition further comprises prompting the AI model to:
identify an owner of the first collection of cloud computing resources based on at least one of a repository indicated in the first collection, an infrastructure as code file indicated in the first collection, a creator or administrator indicated in attribute values, and a permission indicated in resource attribute values;
indicate an environment based on at least one of tags of the first collection and a development pipeline indicated in the first collection; and
describe a business criticality for the first collection based on tags of the first collection.

10. A non-transitory machine-readable medium having program code stored thereon, the program code comprising instructions to:
group a plurality of cloud computing resources by similarity based, at least in part, on a set of one or more attributes of the plurality of cloud computing resources;
generate a set of one or more graphs of the plurality of cloud computing resources based, at least in part, on grouping and pre-defined resource relationships;
extract one or more strongly connected components from each graph based on weights assigned to relationships in the graph and a defined threshold of relationship strength; and
for a first strongly connected component, identify distinct values of at least a first attribute of the cloud computing resources indicated in the first strongly connected component, wherein the first attribute corresponds to a business function and the first strongly connected component indicates a first collection of cloud computing resources from the plurality of cloud computing resources; and
prompt an artificial intelligence (AI) model to generate a definition for the first collection of cloud computing resources based, at least in part, on values of attributes of the first collection of cloud computing resources.

11. The non-transitory machine-readable medium of claim 10, wherein the instructions to group the plurality of cloud computing resources by similarity comprise at least one of instructions to invoke a clustering algorithm on the plurality of cloud computing resources with each cloud computing resource represented by an embedding of values of the one or more attributes, instructions to invoke a clustering algorithm on the plurality of cloud computing resources based on term frequency-inverse document frequency (TF-IDF) scores for the plurality of cloud computing resources based on attribute values, and instructions to group the plurality of cloud computing resources by frequency distribution of values of the one or more attributes.

12. The non-transitory machine-readable medium of claim 10, wherein the instructions to identify distinct values of at least the first attribute of the cloud computing resources indicated in the first strongly connected component comprise instructions to obtain statistical measurements of terms in values of the one or more attributes of the first collection of cloud computing resources according to term frequency-inverse document frequency (TF-IDF) and to select as the distinct values those values with a TF-IDF score that satisfies a defined threshold.

13. The non-transitory machine-readable medium of claim 10, wherein the program code further comprises instructions to:
determine whether one of the first collection of cloud computing resources corresponds to a software bill of materials (SBOM) or results of a software composition analysis (SCA); and
determine a technology stack for the first collection of cloud computing resources based on the SBOM or the SCA results,
wherein the instructions to prompt the AI model to generate the definition comprise instructions to prompt the AI model to generate an application or business function name based, at least in part, on the technology stack.

14. The non-transitory machine-readable medium of claim 10, wherein the instructions to prompt the AI model to generate the definition comprise instructions to prompt the AI model to:
generate a name for the first collection based on at least one of tags of the first collection and an application programming interface endpoint indicated in the first collection; and
generate as a description a summary of the set of attributes, values of the set of attributes of the first collection of cloud computing resources, and the distinct values.

15. The non-transitory machine-readable medium of claim 14, wherein the instructions to prompt the AI model to generate the definition further comprise instructions to prompt the AI model to:
identify an owner of the first collection of cloud computing resources based on at least one of a repository indicated in the first collection, an infrastructure as code file indicated in the first collection, a creator or administrator indicated in attribute values, and a permission indicated in resource attribute values;
indicate an environment based on at least one of tags of the first collection and a development pipeline indicated in the first collection; and
describe a business criticality for the first collection based on tags of the first collection.

16. An apparatus comprising:
a processor; and
a machine-readable medium having instructions stored thereon that are executable by the processor to cause the apparatus to,
group a plurality of cloud computing resources by similarity based, at least in part, on a set of one or more attributes;
generate a set of one or more graphs of the plurality of cloud computing resources based, at least in part, on the grouping and pre-defined resource relationships;
extract one or more strongly connected components from each graph based on weights assigned to relationships in the graph and a defined threshold of relationship strength; and
for a first strongly connected component, identify distinct values of at least a first attribute of the cloud computing resources indicated in the first strongly connected component, wherein the first strongly connected component indicates a first collection of cloud computing resources; and
prompt an artificial intelligence (AI) model to generate a definition for a business function or application inferred from the first collection of cloud computing resources, wherein the instructions to prompt the AI model to generate the definition comprise instructions executable by the processor to cause the apparatus to generate the definition based, at least in part, on values of attributes of the first collection of cloud computing resources.

17. The apparatus of claim 16, wherein instructions to group the plurality of cloud computing resources by similarity comprise instructions executable by the processor to cause the apparatus to, at least one of, invoke a clustering algorithm on the plurality of cloud computing resources with each cloud computing resource represented by an embedding of values of the one or more attributes, invoke a clustering algorithm on the plurality of cloud computing resources based on term frequency-inverse document frequency (TF-IDF) scores for the plurality of cloud computing resources based on attribute values, and group the plurality of cloud computing resources by frequency distribution of values of the one or more attributes.

18. The apparatus of claim 16, wherein the instructions to identify distinct values of at least the first attribute of the cloud computing resources indicated in the first strongly connected component comprise instructions executable by the processor to cause the apparatus to obtain statistical measurements of terms in values of the one or more attributes of the first collection of cloud computing resources according to term frequency-inverse document frequency (TF-IDF) and to select as the distinct values those values with a TF-IDF score that satisfies a defined threshold.

19. The apparatus of claim 16, wherein the machine-readable medium further has stored thereon instructions executable by the processor to cause the apparatus to:
determine whether one of the first collection of cloud computing resources corresponds to a software bill of materials (SBOM) or results of a software composition analysis (SCA); and
determine a technology stack for the first collection of cloud computing resources based on the SBOM or the SCA results,
wherein instructions to prompt the AI model to generate the definition comprises instructions executable by the processor to cause the apparatus to prompt the AI model to generate an application or business function name based, at least in part, on the technology stack.

20. The apparatus of claim 16, wherein the instructions to prompt the AI model to generate the definition comprise instructions executable by the processor to cause the apparatus to prompt the AI model to, at least two of:
generate a name for the first collection based on at least one of tags of the first collection and an application programming interface endpoint indicated in the first collection; and
generate as a description a summary of the set of attributes for the grouping, values of the set of attributes of the first collection of cloud computing resources, and the distinct values.
identify an owner of the first collection of cloud computing resources based on at least one of a repository indicated in the first collection, an infrastructure as code file indicated in the first collection, a creator or administrator indicated in attribute values, and a permission indicated in resource attribute values;
indicate an environment based on at least one of tags of the first collection and a development pipeline indicated in the first collection; and
describe a business criticality for the first collection based on tags of the first collection.
